(19) United States
(12) Patent Application Publication
(10) Pub. No.: US 2018/0150511 A1
(43) Pub. Date: May 31, 2018

(54) PROCESSING A DATA QUERY

(71) Applicant: International Business Machines Corporation, Armonk, NY (US)

(72) Inventors: Yao Liang CHEN, Beijing (CN); Lance Warren FEAGAN, Leawood, KS (US); Sheng HUANG, Shanghai (CN); Yun Jie QIU, Shanghai (CN); Xinlin WANG, Irvine, CA (US); Yu WANG, Shanghai (CN); Xiao Min XU, Beijing (CN)

(21) Appl. No.: 15/363,742

(22) Filed: Nov. 29, 2016

(51) Int. Cl. G06F 17/30; G06N 99/00

(52) U.S. Cl. CPC G06F 17/30451; G06N 99/005; G06F 17/30536

(57) ABSTRACT

A computer-implemented method of processing a data query, includes in an edge device, processing a subquery of the data query, storing first statistical data on the subquery, and analyzing the first statistical data to optimize a parameter for processing subqueries.

### BACKGROUND

The present invention relates generally to processing a data query, and more particularly, to processing a data query in a network environment.

### SUMMARY

An exemplary aspect of the present invention is directed to a computer-implemented method of processing a data query. The method includes in an edge device, processing a subquery of the data query, storing first statistical data on the subquery, and analyzing the first statistical data to optimize a parameter for processing subqueries.

Another exemplary aspect of the present invention is directed to a system for processing a data query, including an edge device including a processor, and a memory, the memory storing instructions to cause the processor to process a subquery of the data query, store first statistical data on the subquery, and analyze the first statistical data to optimize a parameter for processing subqueries.

Another exemplary aspect of the present invention is directed to a method for processing a data query. The method includes in a network device of a network, determining whether the network can process an entirety of the data query, if the network cannot process the entirety of the data query, then decomposing the data query into a plurality of subqueries including a subquery, and transmitting the subquery to an edge device, and storing statistical data on the data query.

Another exemplary aspect of the present invention is directed to a system for processing a data query. The system includes a network device of a network, the network device including a processor, and a memory, the memory operably coupled to the processor and storing instructions to cause the processor to determine whether the network can process an entirety of the data query, if the network cannot process the entirety of the data query, then decompose the data query into a plurality of subqueries including a subquery, and transmit the subquery to an edge device, and store second statistical data on the data query.

Another exemplary aspect of the present invention is directed to a computer program product for processing a data query, the computer program product comprising a computer readable storage medium having program instructions embodied therewith, the program instructions executable by a computer to the computer to, in an edge device, process a subquery of the data query, store first statistical data on the data query, and analyze the first statistical data to optimize a parameter for processing subqueries.

With its unique and novel features, the exemplary aspects of the present invention may provide a user issuing a data query with universal access to the both the cloud environment and an edge environment.

### BRIEF DESCRIPTION OF THE DRAWINGS

The exemplary aspects of the present invention will be better understood from the following detailed description of the exemplary embodiments of the invention with reference to the drawings, in which:

FIG. 1 illustrates a method 100 of processing a data query, according to an exemplary aspect of the present invention;

FIG. 2 illustrates a system 200 for processing a data query, according to another exemplary aspect of the present invention;

FIG. 3 illustrates a method 300 of processing a data query, according to another exemplary aspect of the present invention;

FIG. 4 illustrates a system 400 for processing a data query, according to another exemplary aspect of the present invention;

FIG. 5 illustrates a system 500 for processing a data query, according to another exemplary aspect of the present invention;

FIG. 6. illustrates a system 600 (e.g., architecture for a system 600) for processing a data query, according to another exemplary aspect of the present invention;

FIG. 7 illustrates a data query workflow 700, according to another exemplary aspect of the present invention;

FIG. 8 illustrates an offline rebuild workflow 800, according to another exemplary aspect of the present invention;

FIG. 9 depicts a cloud computing node according to another exemplary aspect of the present invention;

FIG. 10 depicts a cloud computing environment according to another exemplary aspect of the present invention; and

FIG. 11 depicts abstraction model layers according to another exemplary aspect of the present invention.

### DETAILED DESCRIPTION

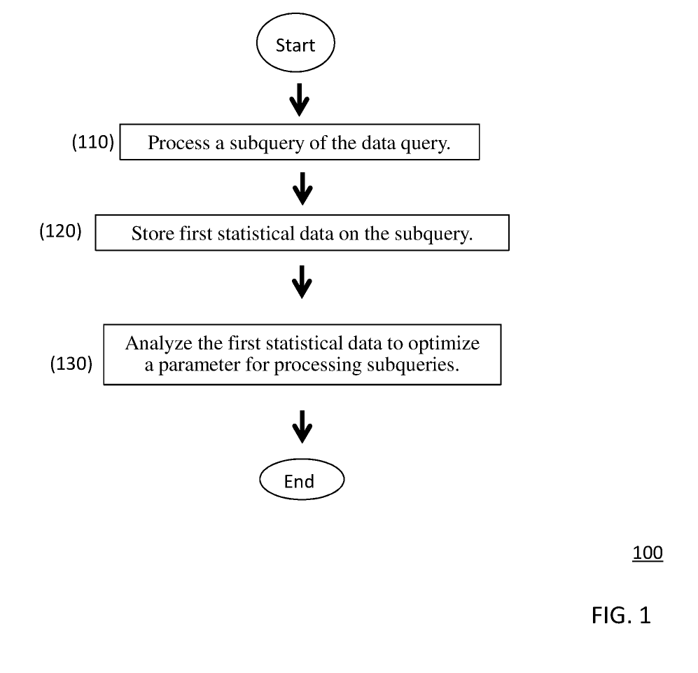

The invention will now be described with reference to FIGS. 1-11, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

A problem with conventional systems and methods, is that they do not support universal access for data queries on both the cloud and edge environments. That is, there is no single entry point which allows a user to have universal access to the cloud and the edge device. Thus, to submit a data query to be processed, the user is required to know where the data are stored and where the data query is to be executed.

The exemplary aspects of the present invention solve the problems of the conventional systems and methods by enabling a user to have universal access to both the cloud and edge environment. This allows a user to simply issue a data query to the cloud as a single entry point, and receive a response to the data query without having to worry about where the data are stored and where the data query is executed.

FIG. 1 illustrates a method 100 (e.g., computer-implemented method) of processing a data query according to an exemplary aspect of the present invention. As illustrated in FIG. 1, the method 100 includes various steps to process the data query. One or more computers of a computer system according to an embodiment of the present invention can include a memory having instructions stored in a storage system to perform the steps of FIG. 1.

Thus, the method 100 of processing a data query according to an exemplary aspect of the present invention may act in a more sophisticated and useful fashion, and in a cognitive manner while giving the impression of cognitive mental abilities and processes related to knowledge, attention, memory, judgment and evaluation, reasoning, and advanced computation. That is, a system is said to be “cognitive” if it possesses macro-scale properties—perception, goal-oriented behavior, learning/memory and action—that characterize systems (i.e., humans) that are generally agreed as cognitive.

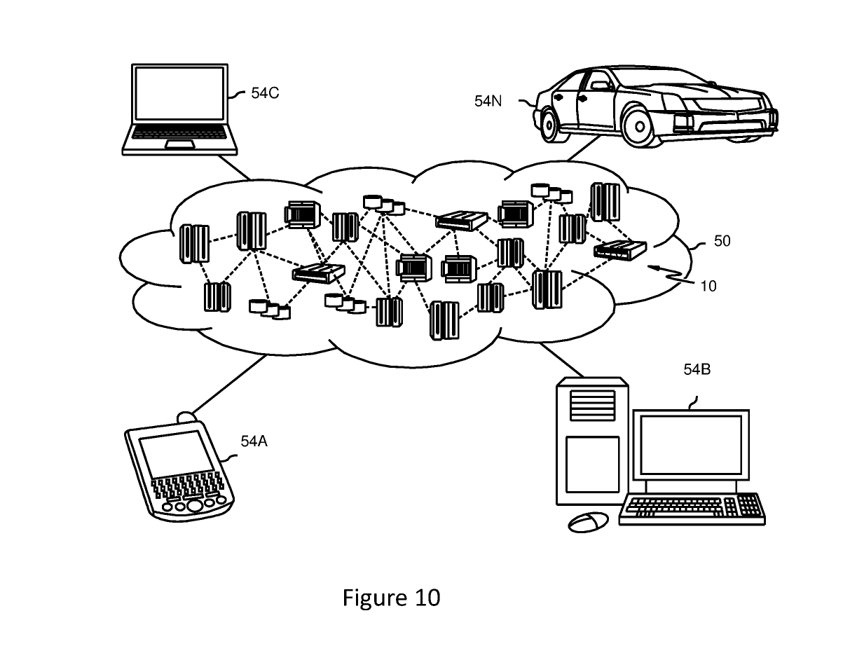

As will be described/illustrated herein, the exemplary aspects of the present invention (see e.g., FIGS. 1-8) may be implemented in a cloud environment 50 (see e.g., FIG. 10).

Referring again to FIG. 1, the method 100 of processing a data query (e.g., a data query received by a network such as the cloud) includes in an edge device, processing (110) a subquery of the data query, storing (120) first statistical data on the subquery, and analyzing (130) the first statistical data to optimize a parameter for processing subqueries. The term “subquery” may be construed to mean a portion of a data query.

The analyzing (130) of the first statistical data may include analyzing the first statistical data to determine a parameter such as workload and bandwidth for computing an aggregation function. The first statistical data may include, for example, data for an offline rebuild workflow process. In particular, the first statistical data may include central processing unit (CPU) data, memory data and network data.

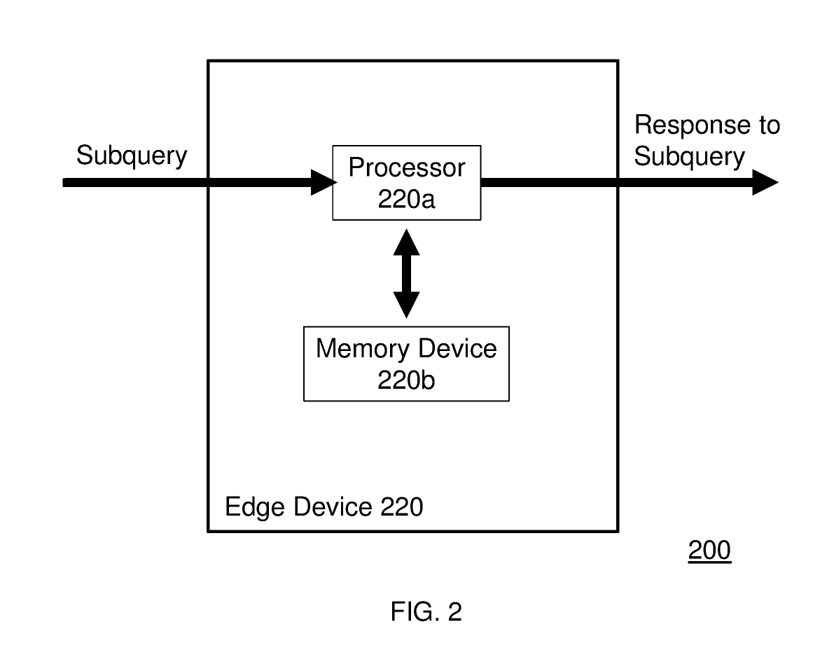

FIG. 2 illustrates a system 200 for processing a data query (e.g., a data query received by a network such as the cloud), according to another exemplary aspect of the present invention.

As illustrated in FIG. 2, the system 200 includes an edge device 220 including a processor 220a, and a memory 220b, the memory 220b storing instructions to cause the processor 220a to process a subquery of the data query, store first statistical data on the subquery, and analyze the first statistical data to optimize a parameter for processing subqueries.

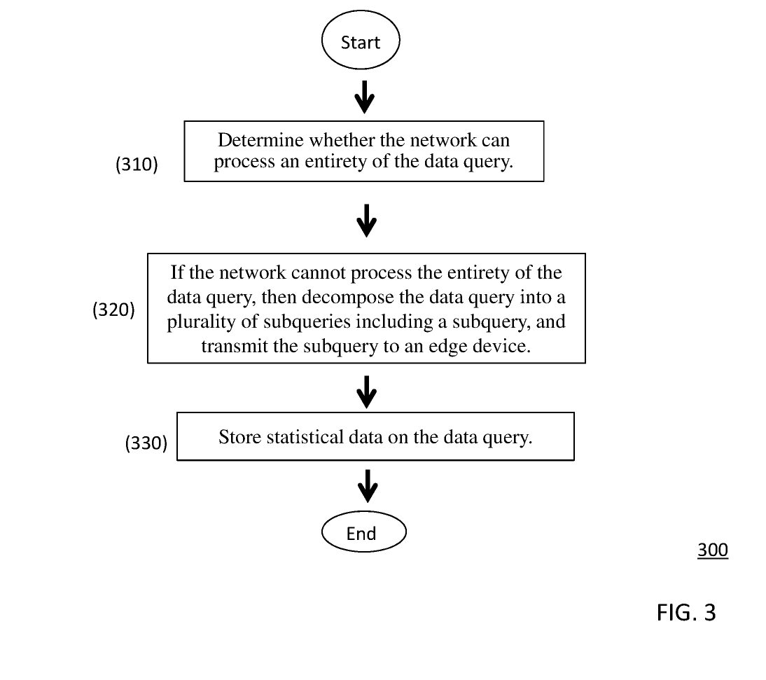

FIG. 3 illustrates a method 300 of processing a data query, according to another exemplary aspect of the present invention.

As illustrated in FIG. 3, the method 300 includes in a network device of a network (e.g., a cloud-computing environment), determining (310) whether the network can process an entirety of the data query, if the network cannot process the entirety of the data query, then decomposing (320) the data query into a plurality of subqueries including a subquery, and transmitting (330) the subquery to an edge device (e.g., edge device 220), and storing statistical data (e.g., device set data, aggregation granularity data, function data, timestamp data, etc.) on the data query.

The determining (310) of whether the network can process the entirety of the data query may include, for example, adaptively determining a granularity and aggregation function of the data query.

The method 300 may also include analyzing the data query to identify an aggregation function (e.g., a plurality of aggregation functions having a plurality of different complexities) to be computed. In this case, the determining (310) of whether the network can process the entirety of the data query, may be based on the analyzing of the data query.

The method 300 may also include in the network device selecting the edge device (e.g., edge device 220) for computing the identified aggregation function, from a plurality of edge devices, and determining a best time period for the selected edge device to compute the identified aggregation function and transmit the computed aggregated function to the network.

The method 300 may also include, in the network device, analyzing the second statistical data to determine an optimal granularity for data to be transmitted to the edge device. In particular, the analyzing of the second statistical data may include using at least one of machine learning and/or data mining to train a model for determining the optimal granularity.

The method 300 may also include providing an entry point which allows a user to have universal access to the network and the edge device.

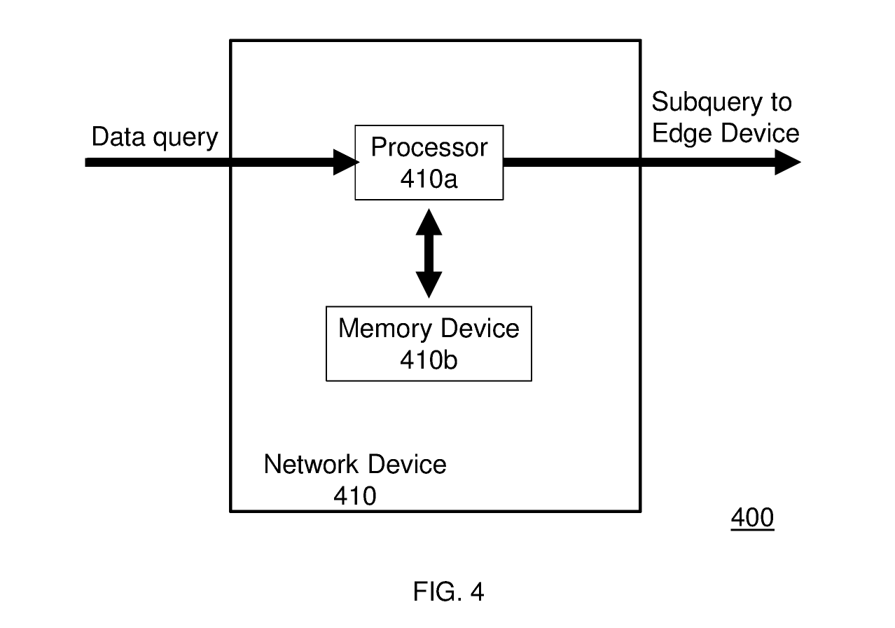

FIG. 4 illustrates a system 400 for processing a data query according to another exemplary aspect of the present invention.

As illustrated in FIG. 4, the system 400 includes a network device 410 of a network, the network device 410 including a processor 410a, and a memory 410b, the memory 410b storing instructions to cause the processor 410a to determine whether the network can process an entirety of the data query, if the network cannot process the entirety of the data query, then decompose the data query into a plurality of subqueries including a subquery, and transmit the subquery to an edge device (e.g., edge device 220), and store second statistical data on the data query.

The term “network” may include a distributed computing environment, such as the cloud environment, and the edge device may include, for example, a device (e.g., server) located at the edge of the network (e.g., at the edge of the cloud). Further, the term “network device” may include one or more devices (e.g., servers) which are connected (directly or indirectly) in the network.

In the system 400, if the data query can be divided into ten (10) subqueries and the network (e.g., the cloud) can only process nine (9) of the ten (10) subqueries (i.e., the network cannot process the entirety of the data query), then the network may decompose the data query into the ten (10) subqueries and transmit the one (1) subquery that it cannot process to an edge device.

The network (e.g., cloud) may be unable to process the data query or some portion (e.g., subquery) of the data query, for example, if the data query requires an especially fine granularity that cannot be provided by the network. The network may be unable to perform one or more of the subqueries which compose the data query, and therefore, may transmit one or more of the subqueries to an edge device (e.g., edge device 220) or a plurality of edge devices.

Further, the network may transmit more than one subquery to the same edge device. For example, if the network device 410 decomposes the data query into 10 subqueries, the network may transmit two of the subqueries to a first edge device, three of the subqueries to a second edge device, and the remaining five subqueries to a third edge device.

Further, the memory 410b may store data that identifies a subquery processing capability for a plurality of edge devices. Prior to transmitting the subqueries, the network device 410 may select an edge device (e.g., edge device 220) for processing a subquery by referring to the stored data. That is, in selecting an edge device to process the subquery, the network device 410 may select an edge device which “corresponds” to the subquery.

The processor 410a may determine whether the network can process an entirety of the data query, for example, by adaptively determining a granularity and aggregation function of the data query.

The processor 410a may also analyze the first statistical data to determine an optimal granularity for data to be transmitted to an edge device. The analyzing of the first statistical data may be performed, for example, by using machine learning and/or data mining to train a model for determining the optimal granularity. The first statistical data may include, for example, device set data, aggregation granularity data, function data and timestamp data.

The system 400 may also include providing an entry point which allows a user to have universal access to a network (e.g., the cloud) and an edge device (e.g., a device at an edge of the network). That is, the user may submit a data query to the network and to an edge device (of a plurality of edge devices) by using the same entry point.

The processor 410a may also analyze the data query to identify an aggregation function (e.g., a plurality of aggregation functions having a plurality of different complexities) to be computed. In this case, the determining of whether the network can process an entirety of the data query may be based on the analyzing of the data query.

The processor 410a may also select an edge device for computing the identified aggregation function, from a plurality of edge devices. In this case, the processor 410a may determine a best time period for the selected edge device to compute the identified aggregation function and transmit the computed aggregated function to the network.

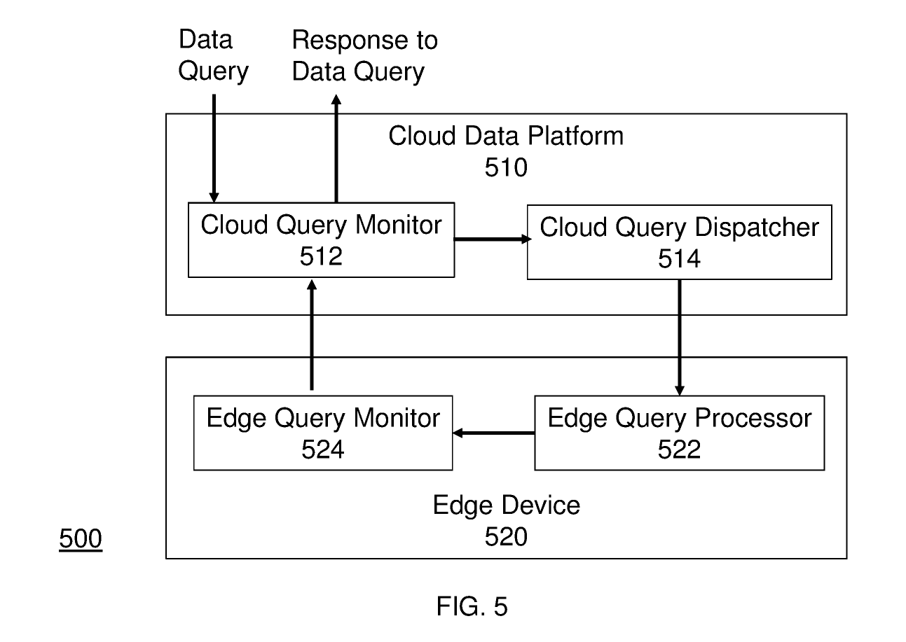

FIG. 5 illustrates a system 500 for processing a data query, according to another exemplary aspect of the present invention.

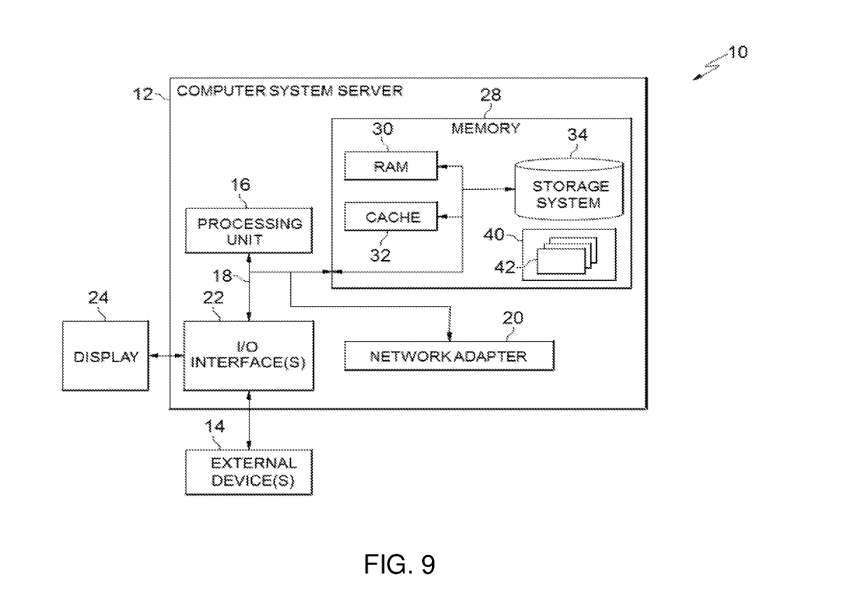

As illustrated in FIG. 5, the system 500 includes a cloud data platform 510 (e.g., a network device) and an edge device 520 (e.g., a device located at the edge of the network). Both the cloud data platform 510 and the edge device 520 may include the features of the cloud computing node 10 illustrated in FIG. 9 and described in detail below.

The cloud data platform 510 may include a cloud query monitor 512 which receives a data query from a user. The cloud query monitor 512 may determine whether the cloud can process an entirety of the data query, and if the cloud cannot process the entirety of the data query, then the cloud query monitor may decompose the data query into a plurality of subqueries. The cloud query monitor 512 may also store first statistical data on the data query.

The cloud data platform 510 may also include a cloud query dispatcher 514 which transmits a subquery of the plurality of subqueries to the edge device 520.

The edge device 520 may include an edge query processor 522 for processing the transmitted subquery (e.g., generating a response to the subquery), and an edge query monitor 524 for storing second statistical data on the transmitted subquery. The edge query monitor 524 may also transmit the response to the subquery back to the cloud query monitor 512 which transmits a response to the data query (including the response to the subquery) back to the user.

The cloud query monitor 512 may determine whether the cloud can process (e.g., generate a response to) the data query by adaptively determining a granularity and aggregation function of the data query.

Further, the edge device 520 may be transparent to the user submitting the data query. That is, the user does not necessarily know that the edge device 520 will be processing the subquery (e.g., generating a response to the subquery).

The cloud query monitor 512 may analyze the first statistical data to determine an optimal granularity for data to be transmitted to the edge device, by using machine learning or data mining to train a model for determining the optimal granularity. The edge query monitor 524 may also analyze the second statistical data to determine a workload and bandwidth for computing an aggregation function.

As illustrated in FIG. 5, the system 500 may provide an entry point which allows a user to have universal access to the cloud and the edge device. That is, the user may submit a data query to the cloud (e.g., the cloud data platform 510) and to the edge device 520 (e.g., a plurality of edge devices) by using the same entry point (i.e., the cloud data platform 510).

The cloud query monitor 512 may also analyze the data query to identify an aggregation function (e.g., a plurality of aggregation functions having a plurality of different complexities) to be computed. In this case, the cloud query monitor 512 may determine whether the cloud can process an entirety the data query based on the analyzing of the data query.

The cloud query monitor 512 may select the edge device 520 for computing the identified aggregation function, from a plurality of edge devices. In this case, the cloud query monitor 512 may determine a best time period for the selected edge device 520 to compute the identified aggregation function and transmit the computed aggregated function to the cloud (e.g., transmit the computed aggregated function to the cloud query monitor 512).

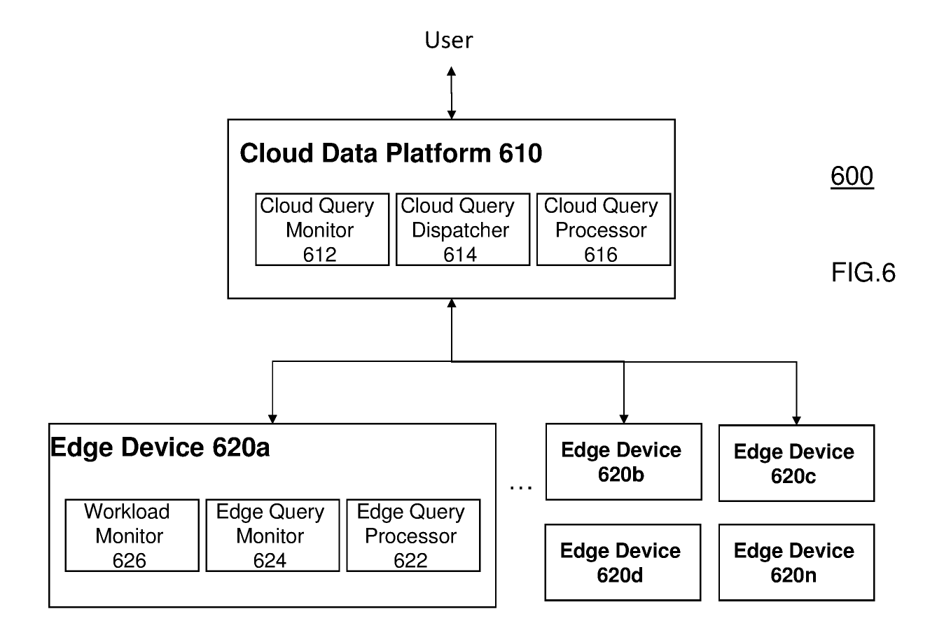

FIG. 6. illustrates a system 600 (e.g., architecture for a system 600) for processing a data query, according to another exemplary aspect of the present invention.

As illustrated in FIG. 6, the system 600 includes a cloud data platform 610 and a plurality of edge devices 620a-620n. The cloud data platform 610 and edge devices 620a-620n may have the features and functions described above with respect to the cloud data platform 510 and an edge device 520, respectively. The edge devices 620a-620n may include, for example, a smart device (e.g., a smart gateway) deployed on the field and able to locally process and manage data (e.g., data from sensors).

In conventional systems for processing data queries, a user would be required to specify where the data queries are to be processed, and the system would need to compute the aggregation values in real-time. In contrast to such conventional systems, the system 600 may provide universal access which enables a user to issue data queries to the cloud environment (e.g., cloud data platform 610) and to the edge environment (e.g., edge devices 620a-620n), as a single entry point, and receive a response to the data queries, without worrying about where the data queries are being processed (e.g., without having to specify where the data queries are to be processed), and without having to compute the aggregation values in real-time.

A user (e.g., plurality of users) may input a data query to the cloud data platform 610 using a user interface. The data query may include a plurality of data queries with different granularities. The user interface may include, for example, a computing device (e.g., computer, mobile phone, server, etc.) connected to the Internet. The user may be a human user or a machine user.

The data query may consist, for example, of granularity and the aggregation function to be performed on a set of devices. For example, a data query can be the average (aggregation function) temperatures every day (granularity) of a building (set of devices) last week.

The system 600 may select a set of data, and more importantly, select an optimal granularity of aggregation data to be transferred and stored to the cloud side. The system 600 may also determine the best time period for the edge device to compute the aggregation functions with different complexity and send the aggregations to cloud.

The cloud data platform 610 may include a cloud query monitor 612 and cloud query monitor 614 (similar to the cloud query monitor 512 and cloud query monitor 514, described above). The cloud data platform 610 may also include a cloud query processor 616 for processing the data query, if the cloud query monitor 612 determines that an entirety of the data query can be processed by the cloud (e.g., if the cloud can generate a response to the data query).

If the cloud query monitor 612 determines that the entirety of the data query cannot be processed by the cloud, then the cloud query dispatcher 614 may decompose the data query into a plurality of subqueries and transmit a subquery of the plurality of subqueries to one or more edge devices 620a-620n. The edge devices 620a-620n include an edge query processor 622 and edge query monitor 624 (similar to the edge query monitor 522 and edge query monitor 524, described above). The edge devices 620a-620n may also include a workload monitor 626 which monitors a workload of the edge devices 620a-620n.

The system 600 may be used, for example, in data management in the Internet-of-Things (IoT). IOT data management may be required to support end-user-friendly real time streaming analytics logic definition and real time processing, and support universal access data queries on both the cloud environment and the edge environment. Some examples of IoT data management include vehicle over speed monitoring and querying, aggregation by time window on air quality data and threshold checking on aggregated pm2.5 data, electrocardiogram (ECG) data monitoring and querying, and power consumption patterning.

The system 600 may be particularly useful in processing data queries for use in managing data in “things” connected to the Internet, such as vehicles, electronic devices and smart homes. The system 600 may also be used, for example, to process telecommunication machine-to-machine data queries, and data queries related to asset intensive industry solutions.

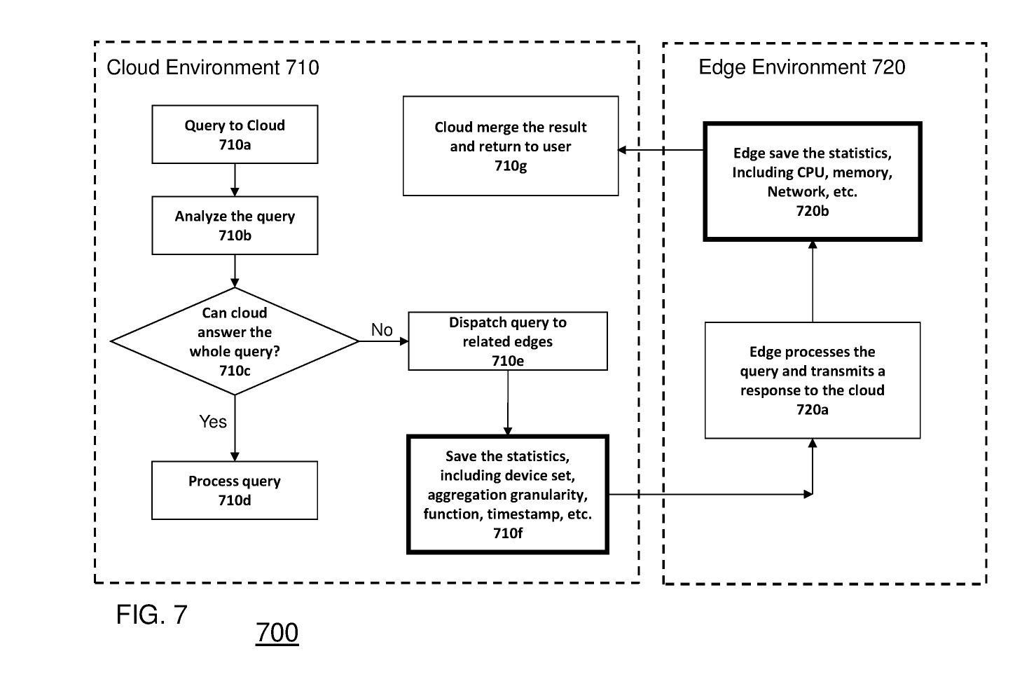

FIG. 7 illustrates a data query workflow 700, according to another exemplary aspect of the present invention. The data query workflow 700 may be performed, for example, by using the system 600.

As illustrated in FIG. 7, the data query workflow 700 includes steps performed in the cloud environment 710 and steps performed in the edge environment 720.

In particular, in the cloud environment 710, a data query is transmitted (710a) to the cloud by the user, the data query is analyzed (710b). Based on the analysis, it is determined whether the cloud can process an entirety of the data query (e.g., answer the entire query). If so, then the cloud processes (710d) the data query.

If not, then the data query may be decomposed into a plurality of subqueries and one or more of the subqueries may be dispatched (710e) to related edges (e.g., edge devices), and the statistics (e.g., device set, aggregation granularity, function, timestamp, etc.) are saved (710f) by the cloud environment 710.

In the edge environment 720, an edge device processes the subquery (that is received from the cloud) and transmits (720a) a response to the subquery back to the cloud environment 710. The edge device also saves (720b) statistics including CPU, memory, network, etc.

The cloud environment 710 receives the response to the subquery from the edge device, and merges the response (e.g., result of processing the entirety of the data query) (710g), and returns the response to the data query to the user.

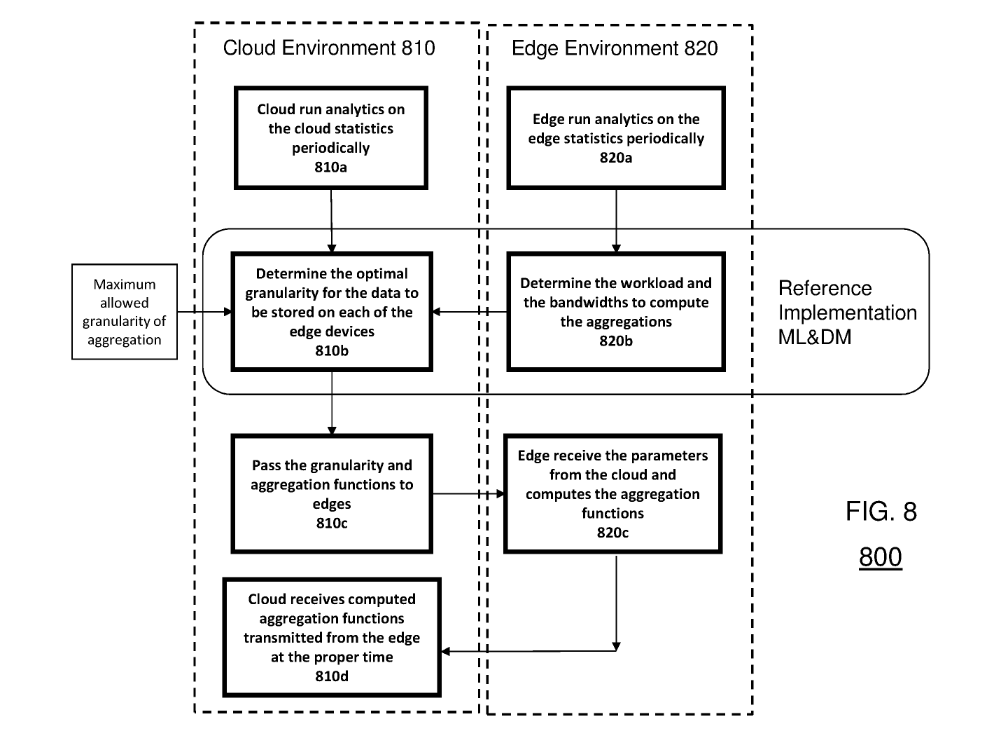

FIG. 8 illustrates an offline rebuild workflow 800, according to another exemplary aspect of the present invention. The offline rebuild workflow 800 may be performed, for example, by using the system 600.

As illustrated in FIG. 8, the offline rebuild workflow 800 includes steps performed in the cloud environment 810 and steps performed in the edge environment 820. The steps may be performed, for example, outside of the times that the system 600 is processing a data query (e.g., when the system is “offline”).

The offline rebuild workflow 800 may provide an adaptive way to determine which granularity and aggregation functions are to be pushed to the edge environment (e.g., edge devices 620a-620n). The offline rebuild workflow 800 may use history data and a query log (e.g., stored by the cloud query monitor 612) to predict the granularity of the data and the query for future data queries.

In particular, the offline rebuild workflow 800 may provide an offline process in which the edge devices 620a-620n process (e.g., compute) the aggregation functions of data queries with some granularity. That is, a data query sent to the cloud may be pre-computed by the edge devices 620a-620n in advance, according to network and workload. The edge devices 620a-620n may also determine the optimal time to process (e.g., compute) a response to the subqueries, and the optimal time to send a response to subqueries back to cloud (e.g., cloud data platform 610).

Referring again to FIG. 8, in the offline rebuild workflow 800, the cloud runs analytics 810a on the cloud statistics (e.g., statistical data stored in the cloud query monitor 612). The cloud may run the analytics periodically, or when instructed by a user.

In addition, the edge may run analytics 820a on the edge statistics (e.g., statistical data stored in the edge query monitor 624). The edge may run the analytics periodically, or when instructed by a user.

In the cloud environment 810, the optimal granularity of the data to be stored on each of the edge devices may be determined 810b. This determination may be based on a result of the analytics 810a, and may take into account the maximum allowed granularity of aggregation (if applicable).

In the edge environment 820, the workload and bandwidths for computing the aggregations may be determined 820b. This determination may be based on a result of the analytics 820a, and a result of this determination may be transmitted to the cloud environment 810, where it is used in the determination 810b of the optimal granularity.

As illustrated in FIG. 8, the determination 810b of the optimal granularity, and the determination 820b of the workload and bandwidths may both be implemented by using machine learning and/or data mining.

The cloud environment 810 may transmit 810c the granularity and aggregation functions to the edge devices. The edge devices may receive the parameters (e.g., the transmitted granularity and aggregation functions) from the cloud environment 810, and compute 820c the aggregation functions. The edge devices then transmit the computed aggregation results by the aggregation functions to the cloud environment 810 at the proper (e.g., optimal) time, and the cloud environment 810 receives 810d the computed aggregation results by the aggregation functions.

The cloud (e.g., cloud query monitor 612) may then store the computed aggregation results by the aggregation functions, and use the stored aggregated results by the aggregation functions in the future, to determine whether the cloud can process an entirety of a data query.

In summary, the exemplary aspects of the present invention may 1) select the data from a set of devices, and more importantly, the optimal granularity of aggregation data and the aggregation functions to be computed and stored on edge side, and 2) determine the best time period for edges to compute the aggregation functions with different complexities and send the aggregations to cloud. These features may allow the exemplary aspects of the present invention to provide several advantages over conventional systems and methods. In particular, the processing of data queries in IoT data management scenarios of asset intensive industry solutions, may be made more efficient and effective by the exemplary aspect of the present invention.

The exemplary aspects of the present invention may include two workflows—a query workflow and an offline rebuild workflow. In the query workflow, the data queries from the cloud side are processed. The cloud side saves the statistics, including device set, aggregation granularity, function, timestamp, etc. The edge device saves the statistics, including CPU, memory, Network, etc. The statistics are the preparations for the offline rebuild workflow, which is the key of this disclosure.

In the offline rebuild workflow, the cloud and edge may determine the optimal parameters according to the statistics data collected in the query workflow using some machine learning or data mining methods. The parameters include the granularity for the data each device to be stored on the edge, and the workload and the bandwidths for a different edge to compute the aggregations. The edge device may then compute the aggregations and sends the results to cloud offline.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Referring again to the drawings, FIGS. 9-11 illustrate other exemplary aspects of the present invention.

It is to be understood that although this disclosure includes a detailed description on cloud computing, implementation of the teachings recited herein are not limited to a cloud computing environment. Instead, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 9, a schematic of an example of a cloud computing node 10 is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 9, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media. System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof.

This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 10 and cloud computing environment 50 can communicate with any type of computerized device over any type of network and/or network addressable connection (e.g., using a web browser).

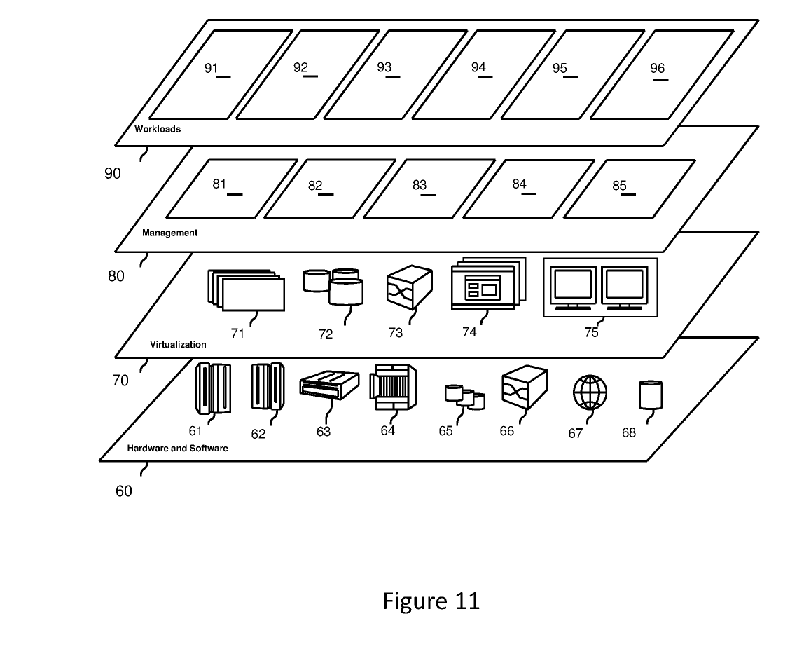

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data query processing 96.

With its unique and novel features, the exemplary aspects of the present invention may provide a user issuing a data query with universal access to the both the cloud environment and an edge environment.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive method and system is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A computer-implemented method of processing a data query, comprising:
in an edge device:
processing a subquery of the data query;
storing first statistical data on the subquery; and
analyzing the first statistical data to optimize a parameter for processing subqueries.

2. The method of claim 1, further comprising:
in a network device of a network:
determining whether the network can process an entirety of the data query;
if the network cannot process the entirety of the data query, then decomposing the data query into a plurality of subqueries including the subquery, and transmitting the subquery to the edge device; and
storing second statistical data on the data query.

3. The method of claim 2, wherein the determining of whether the network can process the entirety of the data query comprises adaptively determining a granularity and aggregation function of the data query.

4. The method of claim 2, wherein the second statistical data comprises at least one member selected from a group consisting of device set data, aggregation granularity data, function data and timestamp data.

5. The method of claim 2, further comprising:
analyzing the data query to identify an aggregation function to be computed,
wherein the determining of whether the network can process the entirety of the data query, is based on the analyzing of the data query.

6. The method of claim 5, wherein the aggregation function comprises a plurality of aggregation functions having a plurality of different complexities.

7. The method of claim 5, further comprising
in the network device:
selecting the edge device for computing the identified aggregation function, from a plurality of edge devices; and
determining a best time period for the selected edge device to compute the identified aggregation function and transmit the computed aggregated function to the network.

8. The method of claim 2, wherein the network comprises a cloud-computing environment.

9. The method of claim 2, further comprising:
in the network device:
analyzing the second statistical data to determine an optimal granularity for data to be transmitted to the edge device.

10. The method of claim 9, wherein the analyzing of the second statistical data comprises using at least one of machine learning and data mining to train a model for determining the optimal granularity.

11. The method of claim 2, further comprising:
providing an entry point which allows a user to have universal access to the network and the edge device.

12. The method of claim 1, wherein the analyzing of the first statistical data comprises analyzing the first statistical data to determine a workload and bandwidth for computing an aggregation function.

13. The method of claim 1, wherein the first statistical data comprises at least one member selected from a group consisting of central processing unit (CPU) data, memory data and network data.

14. The method of claim 1, wherein the first statistical data comprises data for an offline rebuild workflow process.

15. A system for processing a data query, comprising:
an edge device comprising:
a processor; and
a memory, the memory operably coupled to the processor and storing instructions to cause the processor to:
process a subquery of the data query;
store first statistical data on the subquery; and
analyze the first statistical data to optimize a parameter for processing subqueries.

16. The system of claim 15, further comprising:
a network device of a network, the network device comprising:
a processor; and
a memory, the memory storing instructions to cause the processor to:
determine whether the network can process an entirety of the data query;
if the network cannot process the entirety of the data query, then decompose the data query into a plurality of subqueries including the subquery, and transmit the subquery to the edge device; and
store second statistical data on the data query.

17. The system of claim 16, wherein the second statistical data comprises at least one member selected from a group consisting of device set data, aggregation granularity data, function data and timestamp data.

18. The system of claim 16, wherein the processor of the network device comprises:
a network query monitor which receives the data query; and
a network query dispatcher which transmits the subquery.

19. The system of claim 18, wherein the network query monitor determines whether the network can process an entirety of the data query by adaptively determining a granularity and aggregation function of the data query.

20. The system of claim 18, wherein the network query monitor analyzes the second statistical data to determine an optimal granularity for data to be transmitted to the edge device.

21. The system of claim 18, wherein the network query monitor analyzes the second statistical data using at least one of machine learning and data mining to train a model for determining the optimal granularity.

22. The system of claim 18, wherein the network query monitor analyzes the data query to identify an aggregation function to be computed,
wherein the network query monitor determines whether the network can process the entirety of the data query based on the analysis of the data query, and
wherein the aggregation function comprises a plurality of aggregation functions having a plurality of different complexities.

23. The system of claim 16, wherein the network comprises a cloud-computing environment.

24. The system of claim 15, wherein the processor of the edge device comprises
an edge query monitor which stores the first statistical data; and
an edge query processor which processes the subquery.

25. The system of claim 24, wherein the edge query monitor analyzes the first statistical data to determine a workload and bandwidth for computing an aggregation function.

26. The system of claim 15, wherein the first statistical data comprises at least one member selected from a group consisting of central processing unit (CPU) data, memory data and network data.

27. The system of claim 15, wherein the first statistical data comprises data for an offline rebuild workflow process.

28. A computer-implemented method for processing a data query, comprising:
in a network device of a network:
determining whether the network can process an entirety of the data query;
if the network cannot process the entirety of the data query, then decomposing the data query into a plurality of subqueries including a subquery, and transmitting the subquery to an edge device; and
storing statistical data on the data query.

29. A system for processing a data query, comprising:
a network device of a network, the network device comprising:
a processor; and
a memory, the memory storing instructions to cause the processor to:
determine whether the network can process an entirety of the data query;
if the network cannot process the entirety of the data query, then decompose the data query into a plurality of subqueries including a subquery, and transmit the subquery to an edge device; and
store second statistical data on the data query.

30. A computer program product for processing a data query, the computer program product comprising a computer readable storage medium having program instructions embodied therewith, the program instructions executable by a computer to the computer to:
in an edge device:
process a subquery of the data query;
store first statistical data on the data query; and
analyze the first statistical data to optimize a parameter for processing subqueries.
